(19) United States
(12) Patent Application Publication
(10) Pub. No.: US 2026/0222086 A1
(43) Pub. Date: Jul. 30, 2026

(54) DISTRIBUTED RADIO ACCESS NETWORK WITH RADIO UNITS HAVING DIFFERENT TRANSMISSION POWER LEVELS

(71) Applicant: Outdoor Wireless Networks LLC, Richardson, TX (US)

(72) Inventors: Minyan Shi, Bolton, MA (US); Naveen Shanmugaraju, Bangalore (IN); Ehsan Daeipour, Southborough, MA (US); Harsha Hegde, Hawthorn Woods, IL (US)

(73) Assignee: Outdoor Wireless Networks LLC, Richardson, TX (US)

(21) Appl. No.: 19/450,343

(22) Filed: Jan. 15, 2026

Related U.S. Application Data
(60) Provisional application No. 63/745,410, filed on Jan. 15, 2025.

(51) Int. Cl. H04B 17/10; H04B 17/309; H04W 52/24

(52) U.S. Cl. CPC H04B 17/102; H04B 17/347; H04W 52/242

(57) ABSTRACT

One embodiment is directed to a system for serving a cell using a distributed radio access network comprising a distributed unit (DU) and a plurality of radio units (RUs). The system is configured to independently configure a respective RU transmission power level for each of the plurality of RUs, determine a Reference Signal Transmit Power for the cell as a function of one or more of the respective RU transmission power levels for the plurality of RUs, identify one or more UEs mis-estimating a respective path loss measurement therefor, and correct a respective uplink transmit power for each of the one or more UEs mis-estimating path loss measurements therefor. In some embodiments, the system is also configured to correct bias in signal reception metrics used to determine respective simulcast zones and combining zones for each of the UEs mis-estimating the respective path losses therefor.

### CROSS-REFERENCE TO RELATED APPLICATIONS

This application claims the benefit of U.S. Provisional Patent Application Ser. No. 63/745,410, filed on Jan. 15, 2025, which is hereby incorporated herein by reference in its entirety.

### BACKGROUND

As used herein, a distributed radio access network refers to a radio access network (RAN) that is configured to use multiple radio units (RUs) to serve each base station entity (for example, a Fifth Generation (5G) New Radio (NR) gNodeB (gNB)) that is implemented by the RAN.

Various issues and opportunities arise when a distributed RAN is employed to implement a base station entity.

### SUMMARY

One embodiment is directed to a system for serving a cell using a distributed radio access network. The distributed radio access network comprises a distributed unit (DU) and a plurality of radio units (RUs) to wirelessly transmit and receive radio frequency signals to and from user equipment (UE) using a wireless interface. Each of the radio units is associated with a respective set of antennas. The distributed unit is communicatively coupled to the plurality of radio units over a fronthaul network. The system is configured to: independently configure a respective RU transmission power level for each of the plurality of RUs; determine a Reference Signal Transmit Power for the cell as a function of one or more of the respective RU transmission power levels for the plurality of RUs; identify one or more UEs mis-estimating a respective path loss measurement therefor; and correct a respective uplink transmit power for each of the one or more UEs mis-estimating path loss measurements therefor.

Another embodiment is directed to a method of serving a cell using a distributed radio access network comprising a distributed unit (DU) and a plurality of radio units (RUs) to wirelessly transmit and receive radio frequency signals to and from user equipment (UE) using a wireless interface. Each of the radio units is associated with a respective set of antennas. The distributed unit is communicatively coupled to the plurality of radio units over a fronthaul network. The method comprises: independently configuring a respective RU transmission power level for each of the plurality of RUs; determining a Reference Signal Transmit Power for the cell as a function of one or more of the respective RU transmission power levels for the plurality of RUs; identifying one or more UEs mis-estimating a respective path loss measurement therefor; and correcting a respective uplink transmit power for each of the one or more UEs mis-estimating path loss measurements therefor.

The details of various embodiments are set forth in the accompanying drawings and the description below. Other features and advantages will become apparent from the description, the drawings, and the claims.

### BRIEF DESCRIPTION OF DRAWINGS

FIG. 1 is a block diagram illustrating one exemplary embodiment of a distributed radio access network (RAN) system in which the reuse techniques described below can be used.

FIG. 2 comprises a high-level flowchart illustrating one exemplary embodiment of a method of serving a single cell using a distributed radio access network having RUs transmitting at different RU transmission power levels.

FIG. 3 is a diagram illustrating a power control formula for the Physical Uplink Shared Channel.

FIG. 4 is a diagram illustrating a power control formula for the Physical Uplink Control Channel.

Like reference numbers and designations in the various drawings indicate like elements.

### DETAILED DESCRIPTION

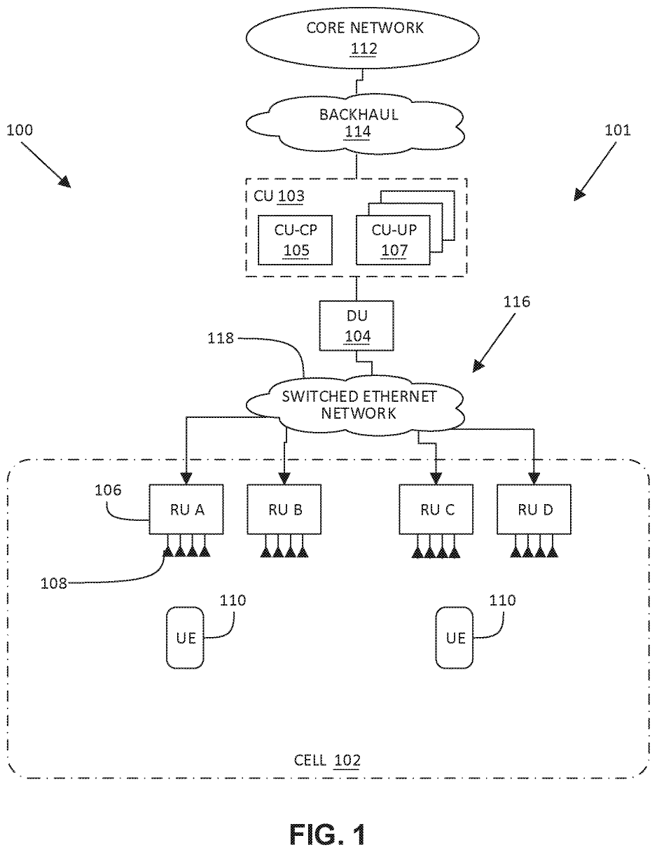

FIG. 1 is a block diagram illustrating one exemplary embodiment of a distributed radio access network (RAN) system 100 serving a single cell 102 using radio units (RUs) 106 transmitting at different RU transmission power levels. The distributed RAN system 100 shown in FIG. 1 implements at least one base station entity 101 (also referred to as a base station 101) to serve at least one cell 102. The distributed RAN system 100 can also be referred to here as a “base station system”, a “system”, or a “RAN”.

In the exemplary embodiment shown in FIG. 1, the system 100 is implemented at least in part using a distributed RAN architecture in which each base station 101 is partitioned into one or more central unit entities (CUs) 103, one or more distributed unit entities (DUs) 104, and multiple radio units (RUs) 106. In such a configuration, each CU 103 implements Layer 3 and non-time critical Layer 2 functions for the base station 101. In the embodiment shown in FIG. 1, each CU 103 is further partitioned into one or more control-plane entities 105 and one or more user-plane entities 107 that handle the control-plane and user-plane processing of the CU 103, respectively. Each such control-plane CU entity 105 is also referred to as a “CU-CP” 105, and each such user-plane CU entity 107 is also referred to as a “CU-UP” 107. Also, in such a configuration, each DU 104 is configured to implement the time critical Layer 2 functions and at least some of the Layer 1 functions for the base station 101. In this example, each RU 106 is configured to implement the physical layer functions for the base station 101 that are not implemented in the DU 104 as well as the radio frequency (RF) interface.

Also, each RU 106 includes or is coupled to one or more antennas 108 via which downlink RF signals are radiated to various items of user equipment (UE) 110 and via which uplink RF signals transmitted by UEs 110 are received.

Although FIG. 1 (and the description set forth below more generally) are described in the context of a Fifth Generation (5G) New Radio (NR) embodiment in which each logical base station entity 101 is partitioned into a CU 103, a DU 104, and RUs 106 and, for at least some of the physical channels, some physical-layer processing is performed in each DUs 106 with the remaining physical-layer processing being performed in the RUs 106, it is to be understood that the techniques described here can be used with other wireless interfaces (for example, Fourth Generation (4G) Long Term Evolution (LTE)) and with other ways of implementing a base station entity that employ multiple radio units (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

In one implementation, each RU 106 is remotely located from each DU 104 serving it. Also, in such an implementation, at least one of the RUs 106 is remotely located from at least one other RU 106 serving that cell 102. In another implementation, at least some of the RUs 106 are co-located with each other, where the respective sets of antennas 108 associated with the RUs 106 are directed to transmit and receive signals to and from different areas or directions.

The RAN system 100 can be implemented in accordance with one or more public standards and specifications. For example, the RAN system 100 can be implemented using a RAN architecture and/or RAN fronthaul interfaces defined by the O-RAN Alliance in order to provide 4G LTE and/or 5G wireless service. (“O-RAN” stands for Open Radio Access Network.) In such an O-RAN example, the DU 104 and RUs 106 can be implemented as O-RAN distributed units and O-RAN remote units, respectively, in accordance with the O-RAN specifications. The RAN system 100 can be implemented in other ways.

The system 100 is coupled to a core network 112 of the associated wireless network operator over an appropriate backhaul 114 (such as the Internet). Also, each DU 104 is communicatively coupled to the RUs 106 served by it using a fronthaul 116. Each of the DU 104 and RUs 106 include one or more network interfaces (not shown) in order to enable the DU 104 and RUs 106 to communicate over the fronthaul 116.

In one implementation, the fronthaul 116 that communicatively couples the DU 104 to the RUs 106 is implemented using a switched ETHERNET network 118. In such an implementation, each DU 104 and RUs 106 includes one or more ETHERNET interfaces for communicating over the switched ETHERNET network 118 used for the fronthaul 116. In one implementation, a lower layer functional split-7-2x based architecture as described in the O-RAN specifications is used for implementing each base station entity 101 and an O-RAN fronthaul interface is used for communication between the DU 104 and the RUs 106 over the fronthaul network 116. In another implementation, a proprietary fronthaul interface is used for communication between the DU 104 and the RUs 106 over the fronthaul network 116 and, for at least some of the physical channels (for example, for the physical downlink shared channel (PDSCH), physical downlink control channel (PDCCH), physical uplink shared channel (PUSCH), physical uplink control channel (PUCCH), and sounding reference signal (SRS) transmissions) lower layer functional split-7-2x based architecture can be used and a different lower layer functional split can be used for at least some of the other physical channels (for example, a lower layer functional split-6 based architecture can be used for the physical random access channel (PRACH)). However, it is to be understood that different functional splits and/or fronthaul interfaces can be used.

Each CU 103, DU 104, and RU 106 (and the functionality described here as being included therein), as well as the system 100 more generally, and any of the specific features described here as being implemented by any of the foregoing, can be implemented in hardware, software, or combinations of hardware and software, and the various implementations (whether hardware, software, or combinations of hardware and software) can also be referred to generally as “circuitry” or a “circuit” or “circuits” configured to implement at least some of the associated functionality. When implemented in software, such software can be implemented in software or firmware executing on one or more suitable programmable processors or configuring a programmable device (for example, processors or devices included in or used to implement special-purpose hardware, general-purpose hardware, and/or a virtual platform). Such hardware or software (or portions thereof) can be implemented in other ways (for example, in an application specific integrated circuit (ASIC), etc.). Also, the RF functionality can be implemented using one or more RF integrated circuits (RFICs) and/or discrete components. Each CU 103, DU 104, RU 106, and the system 100 more generally, can be implemented in other ways.

The distributed RAN 100 is configured so that downlink user data can be wirelessly transmitted from, and uplink user data can be wirelessly received by, one or more radio units 106 of the distributed RAN 100. The set of radio units 106 used for wirelessly transmitting to a UE 110 is also referred to here as the “simulcast zone” for the UE 110, and the set of radio units 106 used for wirelessly receiving from a UE 110 is also referred to here as the “combining zone” for the UE 110. The respective simulcast zone and combining zone can vary from UE 110 to UE 110. The corresponding downlink fronthaul data for each UE 110 must be communicated from the DU 104 over the fronthaul network 116 to each radio unit 106 in that UE's simulcast zone. Also, the corresponding uplink fronthaul data for each UE 110 must be communicated to the DU 104 over the fronthaul network 116 from each radio unit 106 in that UE's combining zone.

The simulcast zone and combining zone can be determined (for example, by the DU 104) based on received power measurements made at each of the radio units 106 serving the cell 102 for one or more uplink transmissions from the UE 110 (for example, Physical Random Access Channel (PRACH) and Sounding Reference Signal (SRS) transmissions). More specifically, each radio unit 106 serving the cell 102 will receive those uplink transmissions and can measure or otherwise determine a signal reception metric indicative of the power level of the transmissions received by that radio unit 106 from the UE 110. One example of such a signal reception metric is a signal-to-noise plus interference ratio (SNIR). The signal reception metrics can then be used to determine the simulcast zones and combining zones for the UE 110. These metrics, and the simulcast zone and combining zone, for each UE 110 can be updated over the course of a UE's connection to the cell 102 (for example, based on SRS transmissions from the UE 110.) Such an approach is based on the assumption that the relative signal reception metrics determined using such uplink transmissions are representative of which remote units 106 the UE 110 will have the best or strongest signal reception characteristics for downlink transmissions made from those radio units 106 and are sufficiently representative for the purpose of determining the simulcast zone for the UE 110.

The distributed RAN 100 shown in FIG. 1 is configured to support one or more different types of frequency reuse. As used here, “downlink frequency reuse” refers to situations where separate downlink user data intended for different UEs 110 is simultaneously wirelessly transmitted to the UEs 110 using the same physical resource blocks (PRBs) for the same cell 102 (that is, using shared frequency resources). As used here, “uplink frequency reuse” refers to situations where separate uplink user data is simultaneously wirelessly transmitted from multiple UEs 110 using the same PRBs for the same cell 102 (that is, using shared frequency resources). Such reuse UEs 110 are also referred to here as being “in reuse” with each other.

For those PRBs where frequency reuse is used, each of the multiple reuse UEs 110 is served by a different subset of the RUs 106, where no RU 106 is used to serve more than one UE 110 for those reused PRBs. That is, for the reused PRBs, the simulcast zone or combining zone for each of the multiple reuse UEs 110 does not include any RU 106 that is included in the simulcast zone or combining zone of any of the other reuse UEs 110. Typically, these situations arise where the reuse UEs 110 are sufficiently physically separated from each other so that the co-channel interference resulting from the different wireless transmissions is sufficiently low (that is, where there is sufficient RF isolation). When this type of frequency reuse is used, the simulcast zone or combining zone for each UE 110 will typically include those radio units 106 that have the “best” or “strongest” signal reception characteristics for that UE 110, assuming those radio units 106 have sufficient capacity.

In one exemplary embodiment, the simulcast zone for each UE 110 can be determined by the serving DU 104 using a “signature vector” (SV) associated with that UE 110. Each element of the signature vector corresponds to one of the radio units 106 used to serve the cell 102 and comprises one or more numerical values associated with the signal reception characteristics at that radio unit for the associated UE 110.

The elements of the signature vector for each UE 110 can be determined based on uplink transmissions from the UE 110. Such an approach is based on the assumption that the relative signal reception metrics determined using such uplink transmissions are representative of which remote units 106 the UE 110 will have the best or strongest signal reception characteristics for downlink transmissions made from those radio units 106 and are sufficiently representative for the purpose of determining the simulcast zone for the UE 110. For example, the signature vector can be determined based on received power measurements made at each of the radio units 106 serving the cell 102 for one or more uplink transmissions from the UE 110 (for example, Physical Random Access Channel (PRACH) and Sounding Reference Signal (SRS) transmissions). More specifically, each radio unit 106 serving the cell 102 will receive those uplink transmissions and can measure or otherwise determine a signal reception metric indicative of the power level of the transmissions received by that radio unit 106 from the UE 110. One example of such a signal reception metric is a signal-to-noise plus interference ratio (SNIR). The signature vector can be updated over the course of a UE's connection to the cell 102 (for example, based on SRS transmissions from the UE 110.

The distributed RAN 100 is configured to support cell deployments where the various RUs 106 serving a cell 102 can be configured to transmit at different power levels. In the following description, “RU transmission power level” refers to the transmission power level used by an RU 106 to serve the cell 102. The RU transmission power level for a RU 106 is provisioned on a cell-by-cell basis at the RU antenna port.

This RU transmission power level configurability enables additional flexibility to support different deployment use cases. Use cases include, but are not limited to, the following. In one use case, a single cell 102 can be used to cover multiple zones, where each zone can use RUs 106 with different RU transmission power levels as needed to improve wireless coverage and reduce capital expenditure (CAPEX) for base station equipment. For instance, for a cell 102 covering both indoor and outdoor areas, RUs 106 with lower RU transmission power levels can be used indoors and RUs 106 with medium or high RU transmission power levels can be used outdoors to provide more coverage with fewer RUs 106. In another use case, RUs 106 located at the edge of a cell 102 can be configured to use a RU transmission power level that is lower than the RU transmission power used by RUs 106 located in the interior of the cell 102. This can be done in order to reduce interference to neighboring cells. In another use case, RUs 106 configured to use a low RU transmission power level can be deployed in order to fill coverage holes.

However, there can be issues when the various RUs 106 serving a cell 102 are configured to transmit at different RU transmission power levels.

With 4G LTE and 5G NR, UEs 110 estimate path loss (PL) based on the single Reference Signal Transmit Power value communicated to the UEs 110 for the cell 102 via the System Information Block (SIB) (that is, using the referenceSignalPower information element of 4G LTE SIB2, and the ss-PBCH-BlockPower information element of 5G NR SIB1). That is, a single Reference Signal Transmit Power value is communicated to the UEs 110 for the cell 102 even though the various RUs 106 serving the cell 102 may be configured to use different RU transmission power levels. As a result, some challenges with this approach include determining which transmission power to use as the Reference Signal Transmit Power when RUs 106 of a cell 102 are transmitting at different RU transmission power levels and handling the inaccurate PL estimation that may be experienced by UEs 110 (for example, where a UE 110 is communicating primarily with a RU 106 that is transmitting using a RU transmission power level that does not correspond to the Reference Signal Transmit Power communicated for the cell 102).

When RUs 106 of a cell 102 are transmitting at different RU transmission power levels, if the highest RU transmission power level is used to determine the Reference Signal Transmit Power for the cell 102, UEs 110 located near a RU 106 using a lower RU transmission power level will overestimate the path loss. Such UEs 110 will transmit at a higher power level than necessary until uplink closed-loop transmit power control takes effect. This could cause receiver saturation at the base station 101. If the lowest RU transmission power level is used to determine the Reference Signal Transmit Power, UEs 110 located near a RU 106 using a higher RU transmission power level will underestimate the path loss and transmit at lower power level than needed and experience inferior uplink performance (for example, experience RACH failures, lower initial UL throughput, etc.). If a middle RU transmission power level is used to determine the Reference Signal Transmit Power, there will be a mixture of some UEs 110 overestimating path loss and some UEs 110 underestimating path loss.

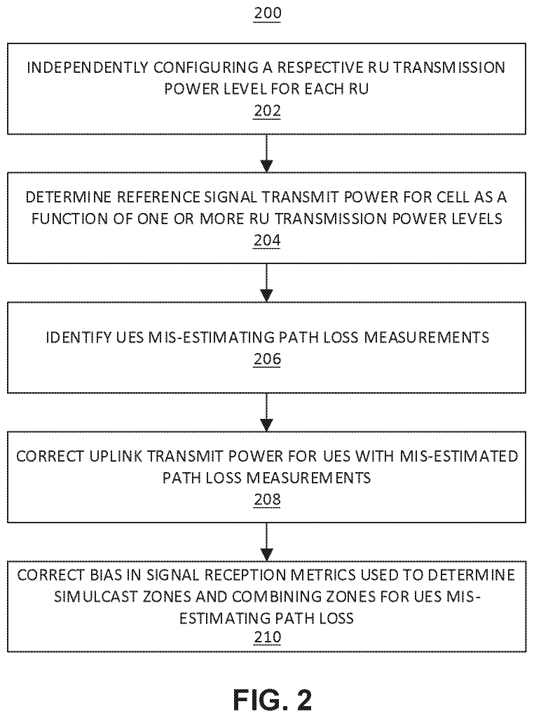

One example of how a single cell 102 can be served using a distributed radio access network having RUs 106 transmitting at different power levels is described below in connection with FIG. 2.

FIG. 2 comprises a high-level flowchart illustrating one exemplary embodiment of a method 200 of serving a single cell using a distributed radio access network having RUs transmitting at different RU transmission power levels. The embodiment of method 200 shown in FIG. 2 is described here as being implemented using the distributed RAN 100 of FIG. 1 (though it is to be understood that other embodiments can be implemented in other ways).

The blocks of the flow diagram shown in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel and/or in an event-driven manner). Also, most standard exception handling is not described for ease of explanation; however, it is to be understood that method 200 can and typically would include such exception handling.

Method 200 comprises independently configuring a respective RU transmission power level for each RU 106 (block 202). In the exemplary embodiment described here in connection with FIG. 1, the RU transmission power level for each RU 106 is provisioned on a cell-by-cell basis at the RU antenna port. As noted above, the RU transmission power level for each RU 106 can be configured independently as needed depending on the use case and the role that the RU 106 plays in the particular deployment. As a result of this, the various RUs 106 in a distributed RAN 100 may have RU transmission power levels that differ from one another.

Method 200 further comprises determining a Reference Signal Transmit Power for the cell 102 as a function of one or more of the respective RU transmission power levels for the RUs 106 used to serve the cell 102 (block 204).

In the exemplary embodiment described here in connection with FIG. 1, the Reference Signal Transmit Power for the cell 102 is specified on a per-resource-element (RE) basis, whereas the RU transmission power levels specified for the RUs 106 serving the cell 102 are not. The RU transmission power level used for determining the Reference Signal Transmit Power for the cell 102 is also referred to here as the “cell reference RU transmission power level” for the cell 102 and is also referred to here using the parameter txP_cellRef. The highest RU transmission power level use by any of the RUs 106 serving the cell 102 is also referred to here using the parameter txP_highest, and the lowest RU transmission power level used by any of the RUs 106 serving the cell 102 is also referred to here using the parameter txP_lowest.

In the exemplary embodiment described here in connection with FIG. 1, if the difference between txP_highest and txP_lowest (that is, txP_highest−txP_lowest) is less than or equal to a predetermined threshold (also referred to here as using the parameter Threshold), txP_cellRef for the cell 102 is set to txP_highest. Otherwise, txP_cellRef for the cell 102 is set to txP_lowest plus the Threshold (that is, txP_lowest+Threshold). The Threshold is a configurable parameter that is determined based on RU receiver margin. For example, if the RU receiver margin is 20 dB, the Threshold can be set to 17 dB.

In the exemplary embodiment described here in connection with FIG. 1, to determine the Reference Signal Transmit Power for the cell 102 from the txP_cellRef, the following equation can be used:

Reference Signal Transmit Power=txP_cellRef−10*log 10(number of subcarriers of the channel bandwidth)+10*log 10(number of antenna ports per RU)

The main reason to use the highest or near highest RU transmission power to determine the Reference Signal Transmit Power for the cell 102 is to avoid Random Access Channel (RACH) performance degradation. This is because if the lowest or near lowest RU transmission power level were used to determine the Reference Signal Transmit Power for the cell 102, UEs 110 located near RUs 106 using a higher RU transmission power would underestimate the UE's pathloss. Such UEs 110 would send their first Physical Random Access Channel (PRACH) preamble with lower transmission power and it may take such UEs 110 multiple PRACH attempts before the preamble transmission power level reaches the target level for base station 101 to successfully decode it.

For example, in one exemplary configuration, the cell reference RU transmission power level used for determining the Reference Signal Transmit Power for the cell 102 (that is, txP_cellRef) is set to the lowest RU transmission power level for any RU 106 serving the cell 102 (that is, txP_lowest) and the difference between txP_highest and txP_lowest (also referred to here using the parameter txPower_delta) is 10 decibels (dB) and the PRACH ramping step (also referred to here using the parameter prachRampingStep) is equal to 2 dB and the RACH response window size (also referred to here using the parameter ra-ResponseWindowSize) is equal to 8 subframes (each subframe having a time-domain length of 1 millisecond (ms)). In this exemplary configuration, it will take UEs 110 located near RUs 106 of the highest RU transmission power 5 attempts (that is, txPower_delta/prachRampingStep) and 40 milliseconds (ms) and (that is, number of attempts*ra-ResponseWindowSize) to ramp up the preamble power to compensate for the path loss underestimation.

If the highest or near highest RU transmission power level is used for determining the Reference Signal Transmit Power for the cell 102, UEs 110 located near RUs 106 using a lower RU transmission power will overestimate the path loss. Such UEs 110 will transmit the initial PRACH preamble with an uplink transmit power at a higher level than needed. However since PRACH occupies only a fraction of total channel bandwidth, the increase in total receiving power due to higher PRACH preamble transmission power should not be significant.

For example, in one exemplary configuration, the PRACH occupies 6 PRBs for LTE, 6 PRBs for FR1-FDD with common subcarrier spacing (SCS) of 15 KHz and PRACH SCS of 15 KHz, and 3 PRBs for FR1-TDD with common SCS of 30 KHz and PRACH SCS of 15 KHz. For a UE 110 that overestimates pathloss by 10 dB, when the UE 110 transmits an initial PRACH preamble with txPower_delta of 10 dB higher than necessary, the total receiving power increase is roughly 1.5 dB and 0.25 dB for 5 MHz and 20 MHz LTE/NR-FDD channels, respectively, and 0.25 dB and 0.15 dB for 40 MHz and 100 MHz TDD channels, respectively.

In addition, an initial PRACH preamble that is transmitted at a higher-than-appropriate power level will most likely be decoded successfully and, therefore, there should be no recurring impact on RU receiving stability.

Method 200 further comprises identifying UEs 110 mis-estimating their respective path loss measurements (block 206) and correcting the respective uplink transmit power for UEs 110 with mis-estimated path loss measurements (block 208).

As noted above, if the highest or near highest RU transmission power level is used for determining the Reference Signal Transmit Power for the cell 102, UEs 110 located near RUs 106 using a lower RU transmission power will overestimate the path loss. Such UEs 110 will also make their initial PUSCH transmissions with an uplink transmit power at a higher level than needed. Unlike an initial PRACH preamble that is transmitted at a higher-than-appropriate power level, an initial PUSCH transmission that is transmitted at a higher-than-appropriate power level due to path loss overcompensation can have a bigger impact on RU receiving stability. This is because a full channel bandwidth allocation for the PUSCH can be made to a UE 110 and the per-resource-block PUSCH target receiving power is usually higher than for the PRACH target receiving power. Using the same example set for above for the PRACH with a txPower_delta of 10 dB, the increase in total receiving power will be equal to the txPower_delta when a full bandwidth allocation for the PUSCH is made to a UE 110 that is overestimating its path loss by amount equal to txPower_delta. For this reason, the DU 104 is configured to identify UE 110s mis-estimating their pathloss and correct their PUSCH, PUCCH, and SRS transmission power levels.

In the exemplary embodiment described here in connection with FIG. 1, the base station 101 (more specifically, the DU 104) is configured to identify the primary serving RU (PRU) 106 of each UE 110 during the RACH process and to track changes in each UE's PRU when each UE 110 is in the RRC_Connected state. This is done as a part of the signature vector processing described above. More specifically, in such an embodiment, each RU 106 serving the cell 102 receives the PRACH transmissions from each UE 110 via each antenna 108 coupled to that RU 106, performs the lower physical layer (LOW PHY) processing of the received PRACH transmissions, and communicates the resulting frequency-domain in-phase and quadrature (IQ) data to the DU 104 for decoding. Upon a successful preamble decoding of a PRACH transmission from a UE 110, the DU 104 will designate the RU 106 reporting the highest PRACH preamble receiving SINR as the primary RU 106 (that is, the PRU) for the UE 110.

If the RU transmission power level for the PRU 106 for a given UE 110 (also referred to here using the parameter txP_PRU) is not equal to the txP_cellRef for the cell 102, the DU 104 considers that UE 110 to be mis-estimating its path loss by an amount equal to the difference between txP_CellRef and txP_PRU (also referred to here using the parameter PL_delta). If the PL_delta is greater than zero, the DU 104 considers the UE 110 to be overestimating its pathloss with the base station 101. Otherwise, if the PL_delta is less than zero, the DU 104 considers the UE 110 to be underestimating its pathloss with the base station 101.

Uplink power control determines UE transmission power for PRACH, PUSCH, PUCCH and SRS. PRACH (preamble) transmission power control is open-loop in the sense that UE 110 determines its transmission power by its own power setting algorithm, based on the UE's internal settings, UE measurements, and base station PRACH parameter configurations. There is no feedback input from the base station 101. The PRACH transmission power (PPRACH) can be determined using the following equation:

$$PPRACH = min ( {P}_{CMAX} , preambleInitialReceivedTargePower + PL )$$

where P_{CMAX} is the UE's maximum transmission power, preambleInitialReceivedTargetPower is the preamble target receiving power configured by the base station 101, PL is the UE's estimation of its path loss with the base station.

PUSCH, PUCCH, and SRS power control are closed-loop. The general formula used for PUSCH, PUCCH, and SRS transmission power can be determined using the following general formula:

Transmit Power=min (UE's maximum transmit power, a target receive power set by the base station+a path loss factor+a modulation and coding scheme (MCS) factor+physical resource block (PRB) factor+a Power Control Command)

The PRACH preambleInitialReceivedTargetPower can be determined as follows. In the following discussion, preambleInitRxTargetP_equalTxP refers to the preambleInitialReceivedTargetPower when all RUs 106 of a cell 102 are transmitting at the same RU transmission power level, and preambleInitRxTargetP_unEqualTxP refers to the preambleinitialReceivedTargetPower when all RUs 106 of a cell 102 are transmitting at different RU transmission power levels.

In the exemplary embodiment described here in connection with FIG. 1, the base station 101 sets the preambleInitRxTargetP_equalTxP such that the receiving power of a first preamble from a UE 110 is at most 6 dB below preambleInitRxTargetP_equalTxP. That is, if either (txP_cellRef=txP_highest) or (txP_cellRef=txP_lowest+Threshold) and (txP_highest−txP_lowest−Threshold<=6 dB), then preambleInitRxTargetP_unEqualTxP is set to preambleInitRxTargetP_equalTxP. Otherwise, preambleInitRxTargetP_unEqualTxP is set to preambleInitRxTargetP_equalTxP+ (txP_highest−(txP_lowest+Threshold)−6 dB).

In the following examples, txP_lowest equals 20 dBm, Threshold is set to 12 dBm, and preambleInitRxTargetP_equalTxP is set to −96 dBm. In a first example, txP_highest equals 30 dBm and, as a result, txP_cellRef is set to txP_highest (that is, 30 dBm in this example) and preambleInitRxTargetP_unEqualTxP is set to preambleInitRxTargetP_equalTxP (that is, −96 dBm in this example). In this first example, no UE 110 will underestimate its path loss and the receiving power of the first PRACH preamble attempt at each RU 106 will be greater than or equal to −96 dBm for any UE 110.

In a second example, txP_highest equals 33 dBm and, as result, txP_cellRef is set to txP_lowest+Threshold (that is, 32 dBm in this example) and preambleInitRxTargetP_unEqualTxP is set to preambleInitRxTargetP_equalTxP (that is, −96 dBm in this example). In this second example, UEs 110 with a PRU having a txP_PRU greater than txP_cellRef will underestimate their path loss by the difference between txP_PRU and txP_cellRef (which will be less than 6 dB) and the receiving power of first PRACH preamble attempts from such UEs 110 will be greater than-102 dBm.

In a third example, txP_highest equals 40 dBm and, as result, txP_cellRef is set to txP_lowest+Threshold (that is, 32 dBm in this example) and preambleInitRxTargetP_unEqualTxP is set to preambleInitRxTargetP_equalTxP+2 dB (that is, −94 dBm in this example). In this third example, UEs 110 with a PRU having a txP_PRU greater than txP_cellRef will underestimate their path loss by the difference between txP_PRU and txP_cellRef (which will be less than 8 dB) and the receiving power of first PRACH preamble attempts from such UEs 110 will be greater than-102 dBm (that is, greater than −94 dBM−8 dB).

In the exemplary embodiment described here in connection with FIG. 1, the 5G NR PUSCH power control defined in the relevant 3GPP specifications (in particular 3GPP Technical Specification 38.213, Section 7.1.1) is used. However, the techniques described below is applicable to both 5G NR and 4G LTE PUSCH power control, where 4G LTE PUSCH power control can be considered as a simplified version of 5G NR PUSCH power control using a single Bandwidth Part (BWP) and numerology μ of 0, where any significant differences are noted below.

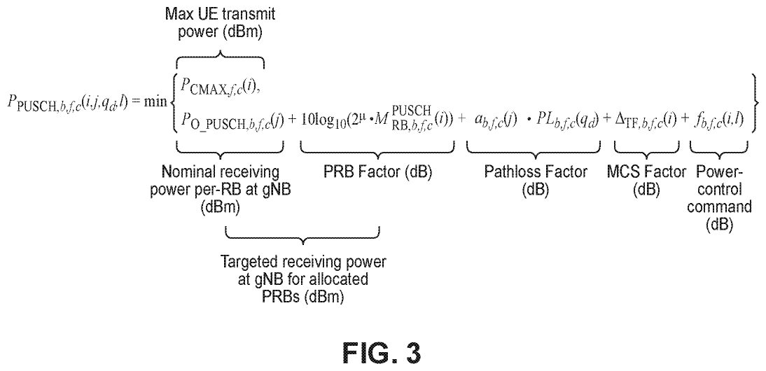

As defined in 3GPP Technical Specification 38.213, Section 7.1.1, if a UE 110 transmits a PUSCH on active UL BWP b of carrier f of serving cell C using parameter set configuration with index j and PUSCH power control adjustment state with index l, the UE 110 determines the PUSCH transmission power P_{PUSCH,b,f,c}(i,j,q_{d},l) in PUSCH transmission occasion i as shown in FIG. 3, where P_{CMAX,f,c}(i) is the configured UE max transmit power, common to all UEs 110 of a cell 102, P_{O_PUSCH,b,f,c}(j)=P_{O_NOMINAL_PUSCH,f,c}(j)+P_{O_USE_PUSCH,b,f,c}(j), where P_{O_NOMINAL_PUSCH,c}(j) is a cell-wide pre-configured per-RB target receiving power at the base station 101 and P_{O_UE_PUSCH,b,f,c}(j) is a preconfigured per-UE nominal receiving power adjustment, M^{PUSCH}_{RB,b,f,c}(i) is number of PRBs allocated to a PDSCH, PL_{b,f,c}(q_{d}) is the path loss estimated by a UE 110, α_{b,f,c}(j) is a path loss fraction ratio configured by the higher layers, Δ_{TF,b,f,c}(i) is a MCS-related adjustment applicable to all UEs 110, f_{b,f,c}(i,l) is the Transmit Power Control (TPC) command. Additional details regarding the calculation and meaning of these factors can be found in the relevant 3GPP specifications. In the exemplary embodiment, P_{O_UE_PUSCH,b,f,c}(j), α_{b,f,c}(j), and f_{b,f,c}(i,l) can potentially be used to correct per-UE PUSCH transmit power.

In the exemplary embodiment described here in connection with FIG. 1, the f_{p,f,c}(i,l) parameter noted above (and in particular the TPC command) can be used to correct the transmit power for Msg3. For 5G Msg3, per the relevant 3GPP specification, j=0, P_{O_UE_PUSCH,b,f,c}(0)=0, P_{O_NOMINAL_PUSCH,f,c}(0)=preambleInitialReceivedTargetPower+deltaPreamble-Msg3 (where both preambleInitialReceivedTargetPower and deltaPreamble-Msg3 are cell-wide configurations), and α_{b,f,c}(0) is a cell-wide value from msg3-Alpha when provided by the higher layers; otherwise, α_{b,f,c}(0)=1.

For 4G LTE Msg3, per the relevant 3GPP specification, j=2, P_{0_UE_PUSCHc}(2)=0, P_{O_NOMINAL_PUSCHc}(2)=preambleinitialReceivedTargetPower+deltaPreamble-Msg3 (where both preambleInitialReceivedTargetPower and deltaPreamble-Msg3 are cell-wide configurations), and α_{c}(2)=1 and is a cell-wide configuration value.

Therefore, only f_{b,f,c}(i,l) can be used to correct Msg3 transmission power for specific UEs 110. For Msg3, f_{b,f,c}(i,l) corresponds to the TPC command for Msg3 PUSCH field of Msg2.

In the exemplary embodiment described here in connection with FIG. 1, the DU 104 is configured to set the TPC command for Msg3 PUSCH for UEs 110 that mis-estimate the path loss as a function of the PL_delta (that is, the difference between txP_CellRef and txP_PRU), specifically in accordance with Table 1. That is, the DU 104 is configured to set the TPC command for Msg3 PUSCH for UEs 110 that mis-estimate the path loss so that the UEs 110 will transmit at the target or 1 dB higher than the target in order to achieve the desired performance.

TABLE 1

| PL_delta (dB) | TPC (dB) |
|---|---|
| >=6 | −6 |
| 5 | −4 |
| 4 | −4 |
| 3 | −2 |
| 2 | −2 |
| 1 | 0 |
| 0 | 0 |
| −1 | 2 |
| −2 | 2 |
| −3 | 4 |
| −4 | 4 |
| −5 | 6 |
| −6 | 6 |
| −7 | 8 |
| <=−8 | 8 |

All three of the parameters noted above can be used to correct the transmission power for initial PUSCH. That is, P_{O_UE_PUSCH,b,f,c}(j), α_{b,f,c}(j), f_{b,f,c}(i,l) (for j>=to 1 for 5G NR and j<=1 for 4G LTE used for PUSCH (re) transmission of configured/semi-scheduled grant, dynamic grant respectively) can be used to correct the transmission power for initial PUSCH.

In the exemplary embodiment described here in connection with FIG. 1, P_{O_UE_PUSCH,b,f,c}(j) is used to correct the transmission power for initial PUSCH. This is for the following reasons. The parameter ratio α_{b,f,c}(j) is a ratio applied to the path loss estimated by a UE 110. In this exemplary embodiment, even though the base station 101 knows the PL_delta (that is, the pathloss estimation error) for a UE 100, it cannot estimate the absolute path loss for a UE 110 until PUSCH closed-loop power control fully tracks the UE's PUSCH performance and the base station 101 has received a Power Headroom report for the UE 110. Hence, it will be difficult for the base station 101 to choose a proper ratio α_{b,f,c}(j). Besides, α_{b,f,c}(j) is intended by the 3GPP specifications for fractional power control for UEs 110 located at the cell edge. Also, in this exemplary embodiment, P_{O_UE_PUSCH,b,f,c}(j) is chosen to correct the transmission power for initial PUSCH instead of f_{b,f,c}(i,l) because P_{O_UE_PUSCH,b,f,c}(j) has a wide range and finer granularity.

For 5G NR, P_{O_USE_PUSCH,b,c}(j)|_{j>=1} is set to the p0 value of the P0-PUSCH-AlphaSet configured for the UE 110, where the p0 value has a range of −16 dB to 15 dB with 1 dB granularity.

For 4G LTE, P_{O_UE_PUSCHc}(j)|ⱼ₌₁ is set to the p0-UE-PUSCH value configured for the UE 110 to use, where the p0-UE-PUSCH value has a range of −8 dB to 7 dB with 1 dB granularity.

For both 5G NR and 4G LTE, f_{b,f,c}(i,l) (in the case of 5G NR) and f_{c}(i) (in the case of 4G LTE) correspond to the TPC Command in the Downlink Control Information (DCI) of a PUSCH resource allocation. In both 5G NR and 4G LTE, the TPC Command has the same range and granularity. Multiple PUSCH resource allocation attempts will be required to achieve desired correction when |PL_delta|>4 dB.

In the exemplary embodiment described here in connection with FIG. 1, for 5G NR, the DU 104 is configured to set P_{O_UE_PUSCH,b,f,c}(j)|_{j>=1} to be the p0 value of the P0-PUSCH-AlphaSet configured for the UE 110. The value of the 5G NR p0 is selected as a function of the PL_delta for the UE 110. More specifically, if the UE's PL_delta>=16 dB (that is, if the UE 110 overestimates pathloss by 16 dB or more), then the p0 value is set to −16 dB. If the UE's PL_delta<16 dB and PL_delta>−15 dB, then the p0 value is set to −PL_delta. If the UE's PL_delta<−15 dB (that is, if the UE 110 underestimates pathloss by more than 15 dB), then the p0 value is set to 15 dB.

In the exemplary embodiment described here in connection with FIG. 1, for 4G LTE, the DU 104 is configured to set P_{O_UE_PUSCHc}(j)|_{j<=1} to the p0-UE-PUSCH configured for the UE 110 to use. The value of the 4G LTE p0-UE-PUSCH is also selected as a function of the PL_delta for the UE 110. More specifically, if the UE's PL_delta>=8 dB (that is, if the UE 110 overestimates pathloss by 8 dB or more), then the p0-UE-PUSCH value is set to −8 dB. If the UE's PL_delta is <8 dB but PL_delta>−7 dB, then the p0-UE-PUSCH value is set to −PL_delta. If the UE's PL_delta <−7 dB (that is, if the UE 110 underestimates pathloss by more than 7 dB), then the p0-UE-PUSCH value is set to 7 dB.

In the exemplary embodiment described here in connection with FIG. 1, for indoor and outdoor small cell deployments with low UE mobility (pedestrian), PUSCH closed-loop power control already tracks UE SINR changes and, as a result, in such deployments, there is no need to change P_{O_USE_PUSCH,b,c}(j) when the PRU 106 changes for a UE 110 after PUSCH closed-loop power control fully takes effect.

In the exemplary embodiment described here in connection with FIG. 1, the 5G NR PUCCH power control defined in the relevant 3GPP specifications (in particular 3GPP Technical Specification 38.213, Section 7.2.1) is used. However, the techniques described below is applicable to both 5G NR and 4G LTE PUCCH power control, where 4G LTE PUCCH power control can be considered as a simplified version of the 5G NR PUSCH power control using a single BWP, a numerology μ of 0, and long PRACH formats only, where any significant differences are noted below.

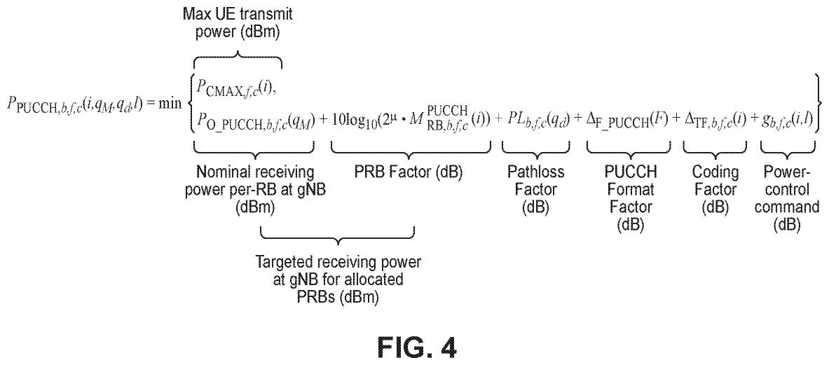

As defined in 3GPP Technical Specification 38.213, Section 7.2.1, if a UE 110 transmits a PUCCH on active UL BWP b of carrier f of serving cell C using PUCCH power control adjustment state with index l, the UE determines the PUCCH transmission power P_{PUCCH,b,c,f,c}(i,qᵤ,q_{d},l) in PUCCH transmission occasion i as shown in FIG. 4, where P_{CMAX,c}(i) is the configured UE max transmit power common to all UEs 110 of a cell 102, P_{O_PUCCH,b,f,c}(qᵤ)=P_{O_NOMINAL_PUCCH}+P_{O_UE_PUCCH}(qᵤ) (where P_{O_NOMINAL_PUCCH} is a cell-wide pre-configured per-RB target receiving power at the base station 101 and P_{O_UE_PUCCH}(qᵤ) is a preconfigured per-UE nominal receiving power adjustment), M^{PUCCH}_{RB,b,f,c}(i) is the number of PRBs allocated to the PUCCH (it is noted that LTE PUCCH format 1/1a/2/2a/2b/3 uses 1 PRB, hence a PRB Factor of 0 dB is used for LTE PUCCH format 1/1a/2/2a/2b/3), PL_{b,f,c}(q_{d}) is the PL estimated by a UE 110, Δ_{F_PUCCH}(F) is a cell-wide parameter common to all UEs 110 (where each Δ_{F_PUCCH}(F) value corresponds to a PUCCH format), Δ_{TF,b,f,c}(i) is a PUCCH format dependent and PUCCH payload size dependent value that is common to all UEs 110 (where the relevant 3GPP specification defines how this value is calculated), and g_{b,f,c}(i,l) is a UE-specific TPC command that is included in the DCI used for PDSCH resource allocation. Additional details regarding the calculation and meaning of these factors can be found in the relevant 3GPP specifications. In the exemplary embodiment, P_{O_PUCCH,b,f,c}(qᵤ) and g_{b,f,c}(i,l) can potentially be used to correct per-UE PUCCH transmission power.

In the exemplary embodiment described here in connection with FIG. 1, the g_{b,f,c}(i,l) parameter noted above (and in particular the TPC command) can be used to correct the UE PUCCH transmission power for acknowledging (ACK/NACK) RACH Msg4 (that is, the contention resolution message) of a contention-based RACH. At the time a UE 110 transmits the acknowledging Msg4, the base station 101 has yet to send a RRC Connection Setup message to the UE 110 and the only UE-specific parameter that can be used for UE PUCCH transmission power correction is g_{b,f,c}(i). According to the relevant 3GPP specification, g_{b,f,c}(i,l)|ᵢ₌₀=g_{b,f,c}(0,l)=deltaPᵣₐₘₚᵤₚ+TPC_{msg2}, where deltaPᵣₐₘₚᵤₚ is the total power ramp-up from the first to the last preamble and is provided by the higher layers, and TPC_{msg2} is the TPC command indicated in the Random Access Response (RAR) (that is, the TPC command for PUSCH field of Msg2) That said, once the base station 101 provides a TPC command in Msg2 for a UE 110 that mis-estimates its path loss, the same TPC command can be used by the UE 110 for correcting the UE transmission power level for the initial PUCCH transmissions (including Msg4).

In the exemplary embodiment described here in connection with FIG. 1, the DU 104 is configured to use P_{O_UE_PUCCH}(qᵤ) for correcting the UE transmission power level for the initial PUCCH transmissions after RRC Connection Setup for the same reasons set for above that the base station 101 uses P_{O_UE_PUSCH,b,f,c}(j)|_{j>=1} for correcting the UE transmission power level for initial PUSCH transmissions.

For 5G NR P_{O_UE_PUCCH}(qᵤ) is set to the p0-PUCCH-Value value configured for the UE 110, where the p0-PUCCH-Value value has a range of −16 dB to 15 dB with 1 dB granularity.

For 4G LTE, P_{O_UE_PUCCH} is set to the p0-UE-PUCCH value configured for the UE 110, where the p0-UE-PUCCH value has a range of −8 dB to 7 dB with 1 dB granularity.

For both 5G NR and 4G LTE, g_{b,f,c}(i,l) (in the case of 5G NR) and g_{c}(i) (in the case of 4G LTE) correspond to the TPC Command in the Downlink Control Information (DCI) of a PDSCH resource allocation. The TPC Command is able to achieve a maximum correction of −1 dB or 3 dB for each PDSCH resource allocation for a UE 110. Multiple PUSCH resource allocation attempts will be required to achieve desired correction when PL_delta is less than 1 dB or greater than −3 dB.

Therefore, as noted above, the DU 104 is configured to use P_{O_UE_PUCCH}(qᵤ) for correcting the UE transmission power level for the initial PUCCH transmissions after RRC Connection Setup. That is, the value of the 5G NR p0-PUCCH-Value is selected as a function of the PL_delta for the UE 110. More specifically, if the UE's PL_delta>=16 dB, then the p0-PUCCH-Value value is set to −16 dB. If the UE's PL_delta<16 dB but PL_delta>−15 dB, then the p0-PUCCH-Value value is set to −PL_delta. If the UE's PL_delta<−15 dB, then the p0-PUCCH-Value value is set to 15 dB.

The value of the 4G LTE p0-UE-PUCCH is also selected as a function of the PL_delta for the UE 110. More specifically, if the UE's PL_delta>=8 dB, then the p0-UE-PUCCH value is set to −8 dB. If the UE's PL_delta<8 dB but PL_delta>−7 dB, then the p0-UE-PUCCH value is set to −PL_delta. If the UE's PL_delta<−7 dB, then the p0-UE-PUCCH value is set to 7 dB.

In the exemplary embodiment described here in connection with FIG. 1, as is the case for PUSCH, for indoor and outdoor small cell deployments with low UE mobility (pedestrian), PUCCH closed-loop power control already tracks UE SINR changes and, as a result, in such deployments, there is no need to change P_{O_UE_PUCCH,b,f,c}(q_{d}) for 5G NR and P_{O_UE_PUCCH,c}( ) for 4G LTE when the PRU 106 changes for a UE 110 after PUCCH closed-loop power control fully takes effect.

In the exemplary embodiment described here in connection with FIG. 1, the DU 104 is configured to correct the UE transmission power levels for SRS transmissions made by UEs 110 that have mis-estimated their path loss using the same UE transmission power correction technique described above for the PUSCH.

In other embodiments, other ways of correcting UE transmission levels for UEs that have mis-estimated their path loss can be used.

As shown in FIG. 2, method 200 further comprises correcting bias in signal reception metrics used to determine simulcast zones and combining zones for UEs 110 mis-estimating their path loss (block 210). In the exemplary embodiment described here in connection with FIG. 1, the DU 104 can be configured to do this for each RU 106 serving the cell 102 by subtracting from the respective signal reception metric for that RU 106 the difference between the txP_cellRef for the cell 102 and the RU transmission power level configured for that RU 106. As a result, such bias in the signal reception metrics can be alleviated.

The techniques described above provide a distributed RAN 100 that supports cell deployments where the various RUs 106 serving a cell 102 can be configured to transmit at different RU transmission power levels while avoiding issues associated with using a single Reference Signal Transmit Power for the cell 102. The resulting RU transmission power level configurability enables additional flexibility to support different deployment use cases. Use cases include, but are not limited to, a use case in which a single cell 102 can be used to cover multiple zones, where each zone can use RUs 106 with different RU transmission power levels as needed to improve wireless coverage and reduce CAPEX for base station equipment, a use case in which RUs 106 located at the edge of a cell 102 are configured to use a RU transmission power level that is lower than the RU transmission power used by RUs 106 located in the interior of the cell 102 in order to reduce interference to neighboring cells, and a use case in which RUs 106 having a low RU transmission power level are deployed in order to fill coverage holes.

Also, this approach simplifies operation of the distributed RAN 100, for example, by avoiding additional Physical Cell Identifier (PCI), Root Sequence Index (RSI), and Cell Radio Network Temporary Identifier (C-RNTI) planning that would be associated with deploying multiple cells to cover multiple zones by instead deploying a single cell to cover the multiple zones. This approach is applicable to base stations implemented for both 5G NR, 4G LTE, and other wireless protocols.

Other embodiments can be implemented in other ways.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### Example Embodiments

Example 1 includes a system for serving a cell using a distributed radio access network comprising: a distributed unit (DU); and a plurality of radio units (RUs) to wirelessly transmit and receive radio frequency signals to and from user equipment (UE) using a wireless interface, each of the radio units associated with a respective set of antennas; wherein the distributed unit is communicatively coupled to the plurality of radio units over a fronthaul network; and wherein the system is configured to: independently configure a respective RU transmission power level for each of the plurality of RUs; determine a Reference Signal Transmit Power for the cell as a function of one or more of the respective RU transmission power levels for the plurality of RUs; identify one or more UEs mis-estimating a respective path loss measurement therefor; and correct a respective uplink transmit power for each of the one or more UEs mis-estimating path loss measurements therefor.

Example 2 includes the system of Example 1, wherein the system further comprises a central unit (CU).

Example 3 includes the system of Example 2, wherein the CU comprises at least one CU control-plane (CU-CP) unit and at least one CU user-plane (CU-UP) unit.

Example 4 includes the system of any of Examples 1-3, wherein the system is configured to use a respective simulcast zone for each UE, wherein the respective simulcast zone for each UE comprises a respective subset of the plurality of RUs used to wirelessly transmit to that UE; wherein the system is configured to use a respective combining zone for each UE, wherein the respective combining zone for each UE comprises a respective subset of the plurality of RUs used to wirelessly receive from that UE.

Example 5 includes the system of Example 4, wherein the system is configured to determine the respective simulcast zone and respective combining zone for each UE using signal reception metrics determined based on uplink transmissions from that UE received at each of the plurality of RUs; and wherein the system is configured to correct bias in the signal reception metrics used to determine the respective simulcast zones and combining zones for each of the UEs mis-estimating the respective path losses therefor.

Example 6 includes the system of Example 5, wherein the system is configured to determine the Reference Signal Transmit Power for the cell as a function of a cell reference RU transmission power for the cell (txP_cellRef); and wherein the system is configured to correct bias in the signal reception metrics used to determine the respective simulcast zones and combining zones for each of the UEs mis-estimating the respective path losses therefor by, for the respective signal reception metric determined for each of the plurality of RUs based on a reference transmission from that UE, subtracting a difference between the txP_cellRef and the respective RU transmission power level for that RU.

Example 7 includes the system of any of Examples 1-6, wherein each of the plurality of RUs supports multiple channels and uses multiple antenna ports; and wherein the system is configured to independently configure the respective RU transmission power level for each of the plurality of RUs by provisioning the respective RU transmission power level on a per-channel basis at the RU antenna ports.

Example 8 includes the system of Example 7, wherein the system is configured to determine the Reference Signal Transmit Power for the cell by: determining a cell reference RU transmission power for the cell (txP_cellRef), wherein the txP_cellRef is set to a highest RU transmission power level configured for the plurality of RUs (txP_highest) if a difference between the txP_highest and a lowest RU transmission power level configured for the plurality of RUs (txP_lowest) is less than or equal to a predetermined threshold and is set to txP_lowest plus the predetermined threshold otherwise; and determining the Reference Signal Transmit Power for the cell based on the txP_cellRef.

Example 9 includes the system of any of Examples 1-8, wherein the system is configured to determine the Reference Signal Transmit Power for the cell as a function of a cell reference RU transmission power for the cell (txP_cellRef); and wherein the system is configured to identify one or more UEs mis-estimating a respective path loss measurement therefor by: for each UE: determining a primary RU for that UE; and determining that UE to be mis-estimating the respective path loss for that UE if the respective RU transmission power level of the primary RU is not equal to the txP_CellRef.

Example 10 includes the system of any of Examples 1-9, wherein the system is configured to correct the respective uplink transmit power for each of the one or more UEs mis-estimating path loss measurements therefor: by using one or more of the following to correct the respective uplink transmit power level for each UE: a preconfigured per-UE nominal receiving power adjustment for that UE; a path loss fraction ratio configured by a higher layer; and a transmit power control (TPC) command for that UE.

Example 11 includes a method of serving a cell using a distributed radio access network comprising a distributed unit (DU) and a plurality of radio units (RUs) to wirelessly transmit and receive radio frequency signals to and from user equipment (UE) using a wireless interface, each of the radio units associated with a respective set of antennas, wherein the distributed unit is communicatively coupled to the plurality of radio units over a fronthaul network, the method comprising: independently configuring a respective RU transmission power level for each of the plurality of RUs; determining a Reference Signal Transmit Power for the cell as a function of one or more of the respective RU transmission power levels for the plurality of RUs; identifying one or more UEs mis-estimating a respective path loss measurement therefor; and correcting a respective uplink transmit power for each of the one or more UEs mis-estimating path loss measurements therefor.

Example 12 includes the method of Example 11, wherein the system further comprises a central unit (CU).

Example 13 includes the method of Example 12, wherein the CU comprises at least one CU control-plane (CU-CP) unit and at least one CU user-plane (CU-UP) unit.

Example 14 includes the method of any of Examples 11-13, wherein the system is configured to use a respective simulcast zone for each UE, wherein the respective simulcast zone for each UE comprises a respective subset of the plurality of RUs used to wirelessly transmit to that UE; and wherein the system is configured to use a respective combining zone for each UE, wherein the respective combining zone for each UE comprises a respective subset of the plurality of RUs used to wirelessly receive from that UE.

Example 15 includes the method of Example 14, wherein the method further comprises determining the respective simulcast zone and respective combining zone for each UE using signal reception metrics determined based on uplink transmissions from that UE received at each of the plurality of RUs; and correcting bias in the signal reception metrics used to determine the respective simulcast zones and combining zones for each of the UEs mis-estimating the respective path losses therefor.

Example 16 includes the method of Example 15, wherein the system is configured to determine the Reference Signal Transmit Power for the cell as a function of a cell reference RU transmission power for the cell (txP_cellRef); and wherein correcting bias in the signal reception metrics used to determine the respective simulcast zones and combining zones for each of the UEs mis-estimating the respective path losses therefor by, for the respective signal reception metric determined for each of the plurality of RUs based on a reference transmission from that UE, subtracting a difference between the txP_cellRef and the respective RU transmission power level for that RU.

Example 17 includes the method of any of Examples 11-16, wherein each of the plurality of RUs supports multiple channels and uses multiple antenna ports; and wherein independently configuring the respective RU transmission power level for each of the plurality of RUs comprises provisioning the respective RU transmission power level on a per-channel basis at the RU antenna ports.

Example 18 includes the method of Example 17, wherein determining the Reference Signal Transmit Power for the cell comprises: determining a cell reference RU transmission power for the cell (txP_cellRef), wherein the txP_cellRef is set to a highest RU transmission power level configured for the plurality of RUs (txP_highest) if a difference between the txP_highest and a lowest RU transmission power level configured for the plurality of RUs (txP_lowest) is less than or equal to a predetermined threshold and is set to txP_lowest plus the predetermined threshold otherwise; and determining the Reference Signal Transmit Power for the cell based on the txP_cellRef.

Example 19 includes the method of any of Examples 11-18, wherein the system is configured to determine the Reference Signal Transmit Power for the cell as a function of a cell reference RU transmission power for the cell (txP_cellRef); and wherein identifying one or more UEs mis-estimating a respective path loss measurement therefor by: for each UE: determining a primary RU for that UE; and determining that UE to be mis-estimating the respective path loss for that UE if the respective RU transmission power level of the primary RU is not equal to the txP_CellRef.

Example 20 includes the method of any of Examples 11-19, wherein correcting the respective uplink transmit power for each of the one or more UEs mis-estimating path loss measurements therefor comprises: using one or more of the following to correct the respective uplink transmit power level for each UE: a preconfigured per-UE nominal receiving power adjustment for that UE; a path loss fraction ratio configured by a higher layer; and a transmit power control (TPC) command for that UE.

What is claimed is:

1. A system for serving a cell using a distributed radio access network comprising:
a distributed unit (DU); and
a plurality of radio units (RUs) to wirelessly transmit and receive radio frequency signals to and from user equipment (UE) using a wireless interface, each of the radio units associated with a respective set of antennas;
wherein the distributed unit is communicatively coupled to the plurality of radio units over a fronthaul network; and
wherein the system is configured to:
independently configure a respective RU transmission power level for each of the plurality of RUs;
determine a Reference Signal Transmit Power for the cell as a function of one or more of the respective RU transmission power levels for the plurality of RUs;
identify one or more UEs mis-estimating a respective path loss measurement therefor; and
correct a respective uplink transmit power for each of the one or more UEs mis-estimating path loss measurements therefor.

2. The system of claim 1, wherein the system further comprises a central unit (CU).

3. The system of claim 2, wherein the CU comprises at least one CU control-plane (CU-CP) unit and at least one CU user-plane (CU-UP) unit.

4. The system of claim 1, wherein the system is configured to use a respective simulcast zone for each UE, wherein the respective simulcast zone for each UE comprises a respective subset of the plurality of RUs used to wirelessly transmit to that UE;
wherein the system is configured to use a respective combining zone for each UE, wherein the respective combining zone for each UE comprises a respective subset of the plurality of RUs used to wirelessly receive from that UE.

5. The system of claim 4, wherein the system is configured to determine the respective simulcast zone and respective combining zone for each UE using signal reception metrics determined based on uplink transmissions from that UE received at each of the plurality of RUs; and
wherein the system is configured to correct bias in the signal reception metrics used to determine the respective simulcast zones and combining zones for each of the UEs mis-estimating the respective path losses therefor.

6. The system of claim 5, wherein the system is configured to determine the Reference Signal Transmit Power for the cell as a function of a cell reference RU transmission power for the cell (txP_cellRef); and
wherein the system is configured to correct bias in the signal reception metrics used to determine the respective simulcast zones and combining zones for each of the UEs mis-estimating the respective path losses therefor by, for the respective signal reception metric determined for each of the plurality of RUs based on a reference transmission from that UE, subtracting a difference between the txP_cellRef and the respective RU transmission power level for that RU.

7. The system of claim 1, wherein each of the plurality of RUs supports multiple channels and uses multiple antenna ports; and
wherein the system is configured to independently configure the respective RU transmission power level for each of the plurality of RUs by provisioning the respective RU transmission power level on a per-channel basis at the RU antenna ports.

8. The system of claim 7, wherein the system is configured to determine the Reference Signal Transmit Power for the cell by:
determining a cell reference RU transmission power for the cell (txP_cellRef), wherein the txP_cellRef is set to a highest RU transmission power level configured for the plurality of RUs (txP_highest) if a difference between the txP_highest and a lowest RU transmission power level configured for the plurality of RUs (txP_lowest) is less than or equal to a predetermined threshold and is set to txP_lowest plus the predetermined threshold otherwise; and
determining the Reference Signal Transmit Power for the cell based on the txP_cellRef.

9. The system of claim 1, wherein the system is configured to determine the Reference Signal Transmit Power for the cell as a function of a cell reference RU transmission power for the cell (txP_cellRef); and
wherein the system is configured to identify one or more UEs mis-estimating a respective path loss measurement therefor by:
for each UE:
determining a primary RU for that UE; and
determining that UE to be mis-estimating the respective path loss for that UE if the respective RU transmission power level of the primary RU is not equal to the txP_CellRef.

10. The system of claim 1, wherein the system is configured to correct the respective uplink transmit power for each of the one or more UEs mis-estimating path loss measurements therefor:
by using one or more of the following to correct the respective uplink transmit power level for each UE:
a preconfigured per-UE nominal receiving power adjustment for that UE;
a path loss fraction ratio configured by a higher layer; and
a transmit power control (TPC) command for that UE.

11. A method of serving a cell using a distributed radio access network comprising a distributed unit (DU) and a plurality of radio units (RUs) to wirelessly transmit and receive radio frequency signals to and from user equipment (UE) using a wireless interface, each of the radio units associated with a respective set of antennas, wherein the distributed unit is communicatively coupled to the plurality of radio units over a fronthaul network, the method comprising:
independently configuring a respective RU transmission power level for each of the plurality of RUs;
determining a Reference Signal Transmit Power for the cell as a function of one or more of the respective RU transmission power levels for the plurality of RUs;
identifying one or more UEs mis-estimating a respective path loss measurement therefor; and
correcting a respective uplink transmit power for each of the one or more UEs mis-estimating path loss measurements therefor.

12. The method of claim 11, wherein the system further comprises a central unit (CU).

13. The method of claim 12, wherein the CU comprises at least one CU control-plane (CU-CP) unit and at least one CU user-plane (CU-UP) unit.

14. The method of claim 11, wherein the system is configured to use a respective simulcast zone for each UE, wherein the respective simulcast zone for each UE comprises a respective subset of the plurality of RUs used to wirelessly transmit to that UE; and
wherein the system is configured to use a respective combining zone for each UE, wherein the respective combining zone for each UE comprises a respective subset of the plurality of RUs used to wirelessly receive from that UE.

15. The method of claim 14, wherein the method further comprises determining the respective simulcast zone and respective combining zone for each UE using signal reception metrics determined based on uplink transmissions from that UE received at each of the plurality of RUs; and
correcting bias in the signal reception metrics used to determine the respective simulcast zones and combining zones for each of the UEs mis-estimating the respective path losses therefor.

16. The method of claim 15, wherein the system is configured to determine the Reference Signal Transmit Power for the cell as a function of a cell reference RU transmission power for the cell (txP_cellRef); and
wherein correcting bias in the signal reception metrics used to determine the respective simulcast zones and combining zones for each of the UEs mis-estimating the respective path losses therefor by, for the respective signal reception metric determined for each of the plurality of RUs based on a reference transmission from that UE, subtracting a difference between the txP_cellRef and the respective RU transmission power level for that RU.

17. The method of claim 11, wherein each of the plurality of RUs supports multiple channels and uses multiple antenna ports; and
wherein independently configuring the respective RU transmission power level for each of the plurality of RUs comprises provisioning the respective RU transmission power level on a per-channel basis at the RU antenna ports.

18. The method of claim 17, wherein determining the Reference Signal Transmit Power for the cell comprises:
determining a cell reference RU transmission power for the cell (txP_cellRef), wherein the txP_cellRef is set to a highest RU transmission power level configured for the plurality of RUs (txP_highest) if a difference between the txP_highest and a lowest RU transmission power level configured for the plurality of RUs (txP_lowest) is less than or equal to a predetermined threshold and is set to txP_lowest plus the predetermined threshold otherwise; and
determining the Reference Signal Transmit Power for the cell based on the txP_cellRef.

19. The method of claim 11, wherein the system is configured to determine the Reference Signal Transmit Power for the cell as a function of a cell reference RU transmission power for the cell (txP_cellRef); and
wherein identifying one or more UEs mis-estimating a respective path loss measurement therefor by:
for each UE:
determining a primary RU for that UE; and
determining that UE to be mis-estimating the respective path loss for that UE if the respective RU transmission power level of the primary RU is not equal to the txP_CellRef.

20. The method of claim 11, wherein correcting the respective uplink transmit power for each of the one or more UEs mis-estimating path loss measurements therefor comprises:
using one or more of the following to correct the respective uplink transmit power level for each UE:
a preconfigured per-UE nominal receiving power adjustment for that UE;
a path loss fraction ratio configured by a higher layer; and
a transmit power control (TPC) command for that UE.
